(19) United States
(12) Patent Application Publication
(10) Pub. No.: US 2009/0170369 A1
(43) Pub. Date: Jul. 2, 2009

(54) Electrical connector with stacked ports

(75) Inventors: Hung-Chi Yu, TuCheng (TW); Gang Li, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/317,862

(22) Filed: Dec. 29, 2008

(30) Foreign Application Priority Data
Dec. 29, 2007 (CN) 200720129816.X

(51) Int. Cl. H01R 13/66; H01R 13/40

(52) U.S. Cl. 439/541.5; 439/639

(57) ABSTRACT

An electrical connector adapted for mounting on a printed circuit board (PCB) includes a first, a second and third mating port. The first and second mating ports are of horizontal types relative to the PCB and the third mating port is of vertical type. The first and second mating ports are stacked one over another and the third mating port is located at one side of the first mating port and the second mating port.

### BACKGROUND OF THE INVENTION

1. Field of the Invention

The present invention relates to an electrical connector, more particularly to a stacked electrical connector adapted for being mated with at least three counter connectors.

2. Description of the Related Art

Stacked electrical connectors are widely used for efficiently usage of internal space of an electronic component and/or layout and space of a printed circuit board (PCB), as mentioned in Taiwan Patent Issue No. 504064 (referred as TW '064) and 417850 (referred as TW '850). The electrical connector in TW '064 includes two side-by side vertical tongue portions integrally formed and a metal sheet spaced surrounding the two tongue portions so as to define two side-by-side vertical mating ports of USB type. The connector in TW '850 includes three stacked mating ports one by one of a Modular Jack and two USB types. Said two connectors are currently used and can decrease the occupying area on the PCB.

More and more mating ports are needed to meet current trend of size miniaturization and functional complication. Therefore, more forms defining plurality of mating ports are needed, not only single side-by-side type or single stacked type.

### SUMMARY OF THE INVENTION

Accordingly, an object of the present invention is to provide an stacked electrical connector for saving space on a PCB where the electrical connector mounted.

In order to achieve the object set forth, an electrical connector adapted for mounting on a printed circuit board (PCB) includes a first, a second and a third mating port. The first and second mating ports are of horizontal types relative to the PCB and the third mating port is of vertical type. The first and second mating ports are stacked one over another and the third mating port is located at one side of the first mating port and the second mating port.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a sketch view of an electrical connector in accordance with a first embodiment of the present invention;

FIG. 2 is a sketch view of the electrical connector of the first embodiment from another direction;

FIG. 3 is a sketch view of an electrical connector in accordance with a second embodiment of the present invention;

FIG. 4 is a sketch view of an electrical connector in accordance with a third embodiment of the present invention;

FIG. 5 is a sketch view of an electrical connector in accordance with a forth embodiment of the present invention; and

FIG. 6 is a sketch view of an electrical connector in accordance with a fifth embodiment of the present invention;

### DETAILED DESCRIPTION OF THE INVENTION

Reference will now be made to the drawing figures to describe two embodiments of the present invention in detail.

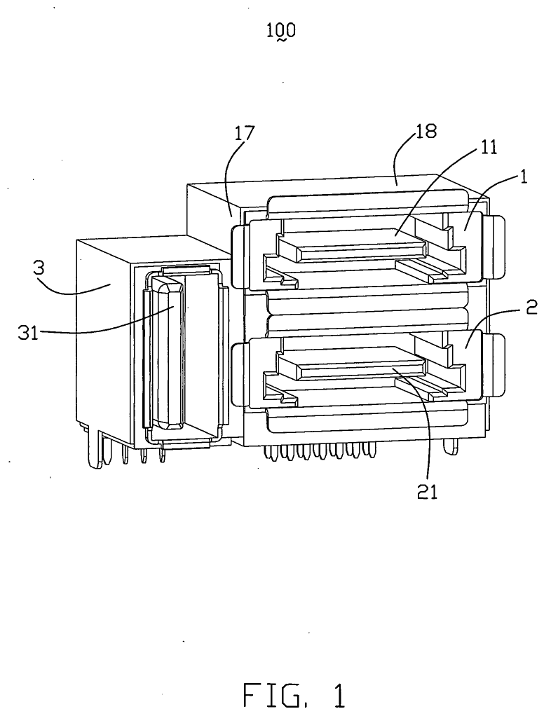

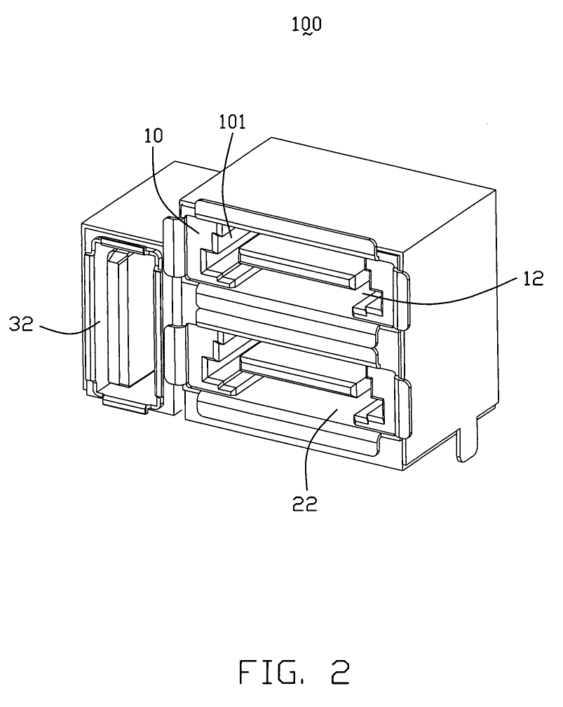

FIGS. 1 and 2 show an electrical connector 100 of a first embodiment of the present invention. The electrical connector 100 includes three single connector bodies, a first and a second connector body 1, 2 both are adapted for transmission ESATA (External Serial Advanced Technology Attachment) signal and a third connector body 3 is USB (Universal Serial Bus) type. The first and second connector bodies are stacked one over another relative to a PCB (not shown) where the electrical connector mounted, thereby forming a stacked connector body 17, and respectively define a horizontal longitudinal tongue portion 11, 21. The third connector body 3 is located at one side (left side) of said stacked connector body 17 and defines a vertical longitudinal tongue portion 31.

The three tongue portions 11, 12, 13 are formed by integrally protruding from an insulating housing 10 and surrounded by inner faces 101 shaped according the counter connectors, thereby three mating port 12, 22, 32 defined. The first mating port 12 and the second mating port 22 are of horizontal type and the third mating port 32 is of vertical type relative to the PCB. The three connector bodies can be formed in a unitary insulating housing. Alternatively, the three connector bodies can be formed single respectively and then arranged together.

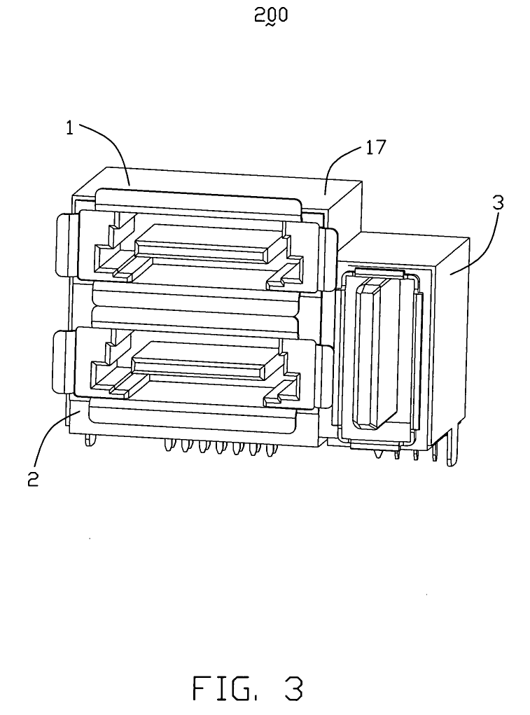

FIG. 3 shows an electrical connector 200 of a second embodiment, which is similar to the first embodiment. For simplicity the same component in this embodiment and following embodiments is designated by a same reference numeral as in the first embodiment and the description of the same component is omitted. The third connector body 3 is arranged at another side (right side) of the stacked connector body 17, while the third connector body 3 of the first embodiment is at left side.

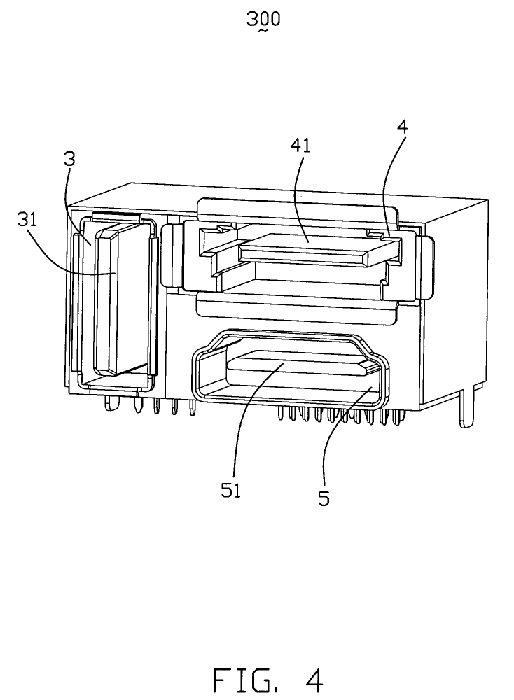

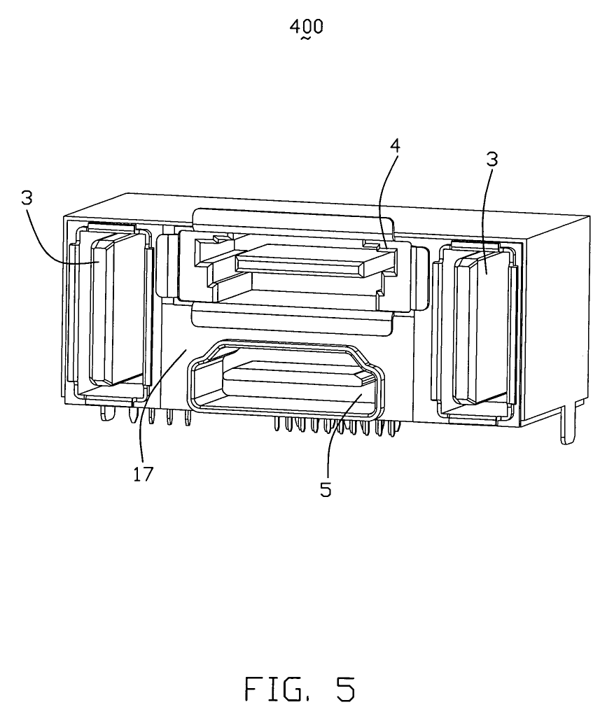

FIG. 4 shows an electrical connector 300 of a third embodiment, which is similar to the first embodiment. The first connector body 4 has an reversed ESATA mating port, the second connector body has a HDMI (High Definition Multimedia Interface) port and the third connector body has the USB port. The three ports are arranged like the pattern of the third embodiment. The second connector body 5 has a horizontal mating tongue portion 51, which is parallel to the first mating tongue portion 41 while perpendicular to the third tongue portion 31. Alternatively as shown in FIG. 5, an electrical connector 400 is provided with two third connector bodies 3 of USB type respective at opposite sides of the stacked connector body 17.

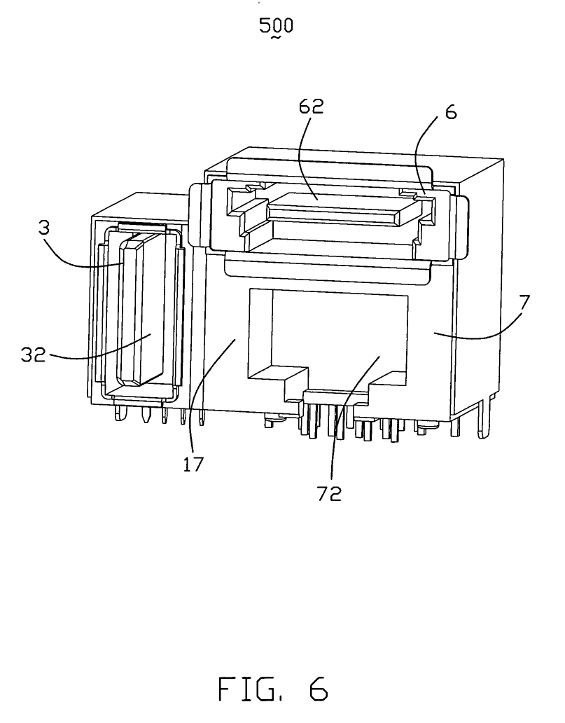

FIG. 6 shows an electrical connector 500 of a fifth embodiment. The connector 500 includes a stacked connector body 17 with a first connector body 6 over a second connector body 7 and a third connector body 3 at one side of the stacked connector body 17. The first connector body 6 defines a reversed ESATA mating port, the second connector body defines a Modular Jack mating port 72 and the third connector body defines the USB mating port 32.

The first and second connector body may both be DisplayPort or one is DisplayPort, alternatively. The detailed structures and components such as contacts of the three connector bodies are omit since the connector types of USB, ESATA, HDMI, DisplayPort and Modular Jack are well know.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector adapted for mounting on a printed circuit board (PCB), comprising:
a first mating port and a second mating port both of horizontal type relative to the PCB, the two mating ports being stacked one over another;
a third mating port of a vertical type relative to the PCB, the third mating port being located at one side of the first mating port and the second mating port.

2. The electrical connector as described in claim 1, wherein the third mating port is of USB type.

3. The electrical connector as described in claim 2, wherein the first and the second mating port can be one type among ESATA, HDMI or DisplayPort, respectively.

4. The electrical connector as described in claim 1, comprising three connector bodies of insulating material each defining one said corresponding mating port, wherein two of said three connector bodies are stacked one over another to form a stacked connector body, the other of said three connector bodies abuts against one side of the stacked connector body.

5. The electrical connector as described in claim 4, further comprising another third connector body, wherein the third connector body is located at another side of the stacked connector body.

6. The electrical connector as described in claim 5, wherein the two third bodies are symmetrically about the stacked connector body.

7. An electrical connector adapted for mating with at least three counter connectors, comprising:
a first connector body and a second connector body, stacked one over another along a first direction;
a third connector body extending along the first direction, located at one side of the first and second connector bodies.

8. An electrical connector assembly for mounting to a printed circuit board, comprising:
a first connector unit defining a first mating port exposed to an exterior in a front-to-back direction;
a second connector unit defining a second mating port exposed to the exterior in said front-to-back direction;
a third connector unit defining a third mating port exposed to the exterior in said front-to-back direction; and
each of said first mating port, said second mating port and said third mating port defining a long side and a short side; wherein
the first connector unit and the second connector unit are aligned with and stacked with each other along the corresponding long sides thereof along a first direction perpendicular to said front-to-back direction, while the third connector unit is staked upon the corresponding short sides of both said first connector unit and said second connector unit along a second direction perpendicular to both said first direction and said front-to-back direction.

9. The electrical connector assembly as claimed in claim 8, wherein the long side of said third connector unit is aligned with the corresponding short sides of the first connector unit and of the second connector unit in said second direction.

10. The electrical connector assembly as claimed in claim 8, wherein insulative housings of said first, second and third connector units are unitarily formed as one piece.

11. The electrical connector assembly as claimed in claim 10, wherein at least one mating port of said first mating port, second mating port and third mating port is equipped with a metallic shell enclosing said at least one mating port while being enclosed in said insulative housings.

12. The electrical connector assembly as claimed in claim 8, wherein said connector assembly is equipped with corresponding contacts configured to be mounted to said printed circuit board in said first direction.

13. The electrical connector assembly as claimed in claim 12, wherein said front-to-back direction is parallel to the printed circuit board.
